(19) United States
(12) Patent Application Publication
(10) Pub. No.: US 2019/0322169 A1
(43) Pub. Date: Oct. 24, 2019

(54) FUEL TANK CAP FOR TWO-WAY GAS INTAKE AND EXHAUSTION

(71) Applicant: I-SIN PENG, Taichung (TW)

(72) Inventor: I-SIN PENG, Taichung (TW)

(21) Appl. No.: 15/956,831

(22) Filed: Apr. 19, 2018

(51) Int. Cl. B60K 15/04; B60K 15/035

(52) U.S. Cl. CPC B60K 15/0406; B65D 55/165; B60K 2015/0438; B60K 15/035

(57) ABSTRACT

A fuel tank cap for two-way gas intake and exhaustion contains: a body including a first lid and a second lid. The first lid has a coupling orifice configured to connect with a pressure adjustment module, the pressure adjustment module has a rotatable knob and a limiting unit, and the first lid has a locking rib. A first spring is defined between the first lid and the second lid, and the second lid includes an accommodation groove and a connection portion. The accommodation groove accommodates a flexible adjustment valve and a second spring, and the flexible adjustment valve has a main part and a flexible stop unit which has a movement travel in which the flexible stop unit expends or retracts. The main part has at least one seal loop and a defining rib. The second spring abuts against the defining rib and the limiting unit.

### FIELD OF THE INVENTION

The present invention relates to a fuel tank cap for two-way gas intake and exhaustion which contains a flexible adjustment valve configured to adjust pressure in the fuel tank so as to enhance stable gas intake and exhaustion.

### BACKGROUND OF THE INVENTION

A pressure in the fuel tank increases as ambient temperature or fuel consumption changes, for example, when ambient temperature increases, the pressure in the fuel tank and the fuel consumption enhances. When the fuel consumption reduces, negative pressure produces in the fuel tank.

Referring to FIGS. 1 and 2, a conventional fuel tank cap 301 contains a pressure adjustment valve 303 having an air orifice so that when pressure in the fuel tank increases, the pressure adjustment valve 303 releases a part of gas. When the negative pressure produces in the fuel tank, the pressure adjustment valve 303 supplements external gas into the fuel tank, thus balancing pressures between the fuel tank and an external environment.

The pressure adjustment valve 303 is comprised of a rubber element 303 and a locking unit 305 connected with a first coupling orifice of the fuel tank cap 301. The locking unit 305 has a second coupling orifice configured to connect with the rubber element in an inverted cone shape, a through hole 3041 extends downward from a top of the rubber element 304 so that when a pressure difference produces in the fuel tank and the external environment, the through hole 3041 adjusts the pressure difference.

However, the pressure adjustment valve 303 has defects as follows:

1. The rubber element 304 ages or deforms easily after a period of using time, thus leaking fuel from the fuel tank.

2. When the pressure difference produces, the pressure adjustment valve 303 cannot resistant against the pressure difference.

Accordingly, the conventional fuel tank cap has poor airtightness, and fuel consumption in the fuel tank is quite high.

The present invention has arisen to mitigate and/or obviate the afore-described disadvantages.

### SUMMARY OF THE INVENTION

The primary aspect of the present invention is to provide a fuel tank cap for two-way gas intake and exhaustion which contains a flexible adjustment valve configured to adjust pressure in the fuel tank so as to enhance stable gas intake and exhaustion.

Further aspect of the present invention is to provide a fuel tank cap for two-way gas intake and exhaustion which contains a flexible adjustment valve carburized surface treatment so as to have anti-deformation and high-pressure resistance.

Another aspect of the present invention is to provide a fuel tank cap for two-way gas intake and exhaustion which contains at least one seal loop fitted on the flexible adjustment valve so as to matingly contact with the accommodation groove.

To obtain the above aspects, a fuel tank cap for two-way gas intake and exhaustion provided by the present invention contains: a body including a first lid and a second lid.

The first lid has a coupling orifice configured to connect with a pressure adjustment module, the pressure adjustment module has a rotatable knob and a limiting unit, and the first lid has a locking rib formed on a bottom of an inner wall thereof. A first spring is defined between the inner wall of the first lid and the second lid, a first end of the first spring is fitted on an inner wall of the limiting unit, and a second end of the first spring is fitted on an upper end of the second lid. The second lid is fitted with the inner wall of the first lid, and a bottom of the second lid retains with the locking rib. The second lid includes an accommodation groove formed on a central portion thereof, and the second lid includes a connection portion arranged on an inner wall of the second lid.

The accommodation groove of the second lid accommodates a flexible adjustment valve and a second spring, and the flexible adjustment valve has a main part and a flexible stop unit, wherein the flexible stop unit is connected with the main part, and the flexible stop unit has a movement travel in which the flexible stop unit expends or retracts, the main part has at least one seal loop fitted on an outer wall thereof so as to matingly contact with the accommodation groove, and the main part has a defining rib, wherein a first end of the second spring abuts against the defining rib, and a second end of the second spring is biased against the limiting unit.

Preferably, the accommodation groove is formed in an inverted cone shape.

Preferably, the flexible stop unit is fitted with a flexible washer so as to close the flexible stop unit.

Preferably, the flexible adjustment valve is carburized surface treatment.

Preferably, the second lid further includes a threaded section formed on the inner wall thereof so as to screw the body with an oil inlet of a fuel tank.

Preferably, the second lid further includes a locating paw element inserted into a fuel tank and configured to prevent a removal of the body from the fuel tank.

Furthermore, the flexible adjustment valve has a returning spring housed therein so that when the body draws the gas, the returning spring pushes the flexible stop unit to descend so as to supplement the pressure of the fuel tank. When the pressure of the fuel tank is equal to the external environment, the returning spring pushes the flexible stop unit to move back to an original position.

When a pressure produces in the fuel tank, the rotatable knob is rotated tightly or loosely so that gas flows into the fuel tank from external environment. Thereafter, the flexible stop unit is pulled by the pressure of the fuel tank to move downward in the movement travel so that the gas flows into the fuel tank from the external environment via the first lid, the second lid and the flexible adjustment valve, and the pressure of the fuel tank is equal to a pressure of the external environment.

When the gas exhausts out of the fuel tank, the flexible adjustment valve is pushed by the pressure so that the gas exhausts out of the fuel tank along the second lid and the first lid. After the pressure of the fuel tank is equal to that of the external environment, the second spring and the second spring push the flexible adjustment valve to move back to an original position, thus avoiding leakage of fuel oil and the gas and enhance using safety.

### BRIEF DESCRIPTION OF THE DRAWINGS

FIG. 1 is a cross sectional view showing the assembly of a conventional fuel tank cap.

FIG. 2 is a cross sectional view showing the application of the conventional fuel tank cap.

FIG. 3 is a perspective view showing the assembly of a fuel tank cap for two-way gas intake and exhaustion according to a preferred embodiment of the present invention.

FIG. 4 is a perspective view showing the exploded components of the fuel tank cap for two-way gas intake and exhaustion according to the preferred embodiment of the present invention.

FIG. 5 is a cross sectional view showing the assembly of the fuel tank cap for two-way gas intake and exhaustion according to the preferred embodiment of the present invention.

FIG. 6 is a cross sectional view showing the exploded components of the fuel tank cap for two-way gas intake and exhaustion according to the preferred embodiment of the present invention.

FIG. 7 is a cross sectional view showing the assembly of a part of the fuel tank cap for two-way gas intake and exhaustion according to the preferred embodiment of the present invention.

FIG. 8 is another cross sectional view showing the assembly of a part of the fuel tank cap for two-way gas intake and exhaustion according to the preferred embodiment of the present invention.

FIG. 9 is a cross sectional view showing the application of the fuel tank cap for two-way gas intake and exhaustion according to the preferred embodiment of the present invention.

FIG. 10 is another cross sectional view showing the application of the fuel tank cap for two-way gas intake and exhaustion according to the preferred embodiment of the present invention.

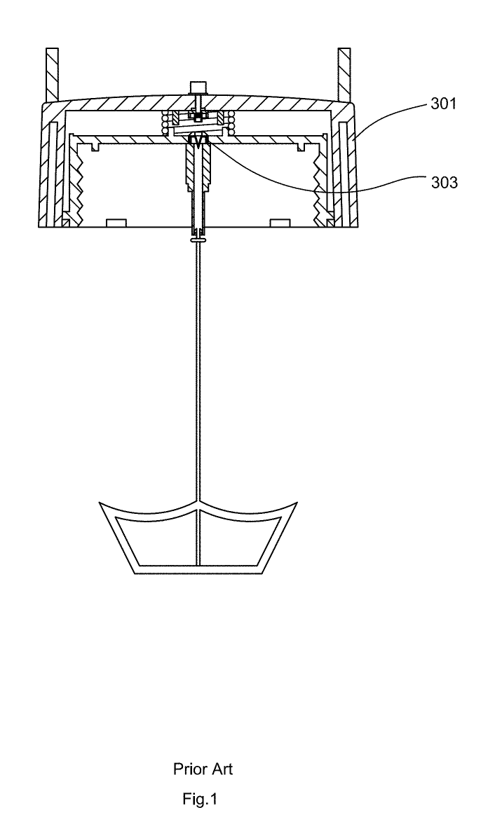

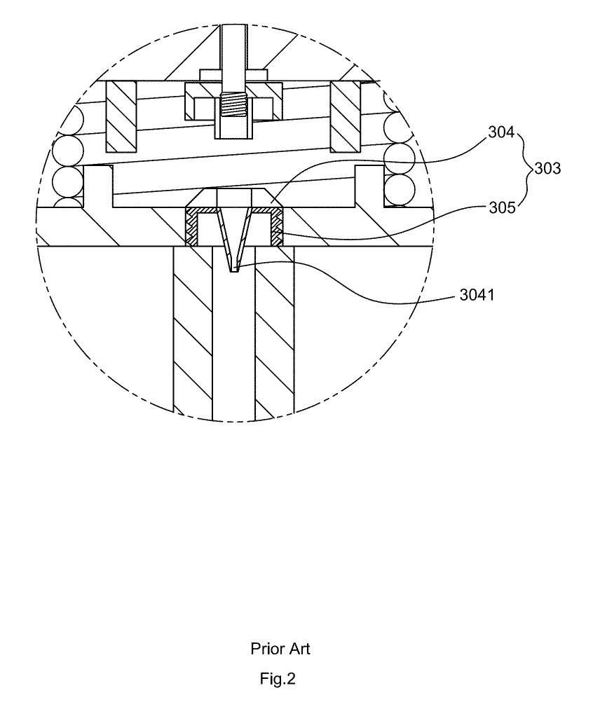

### DESCRIPTION OF THE PREFERRED EMBODIMENTS

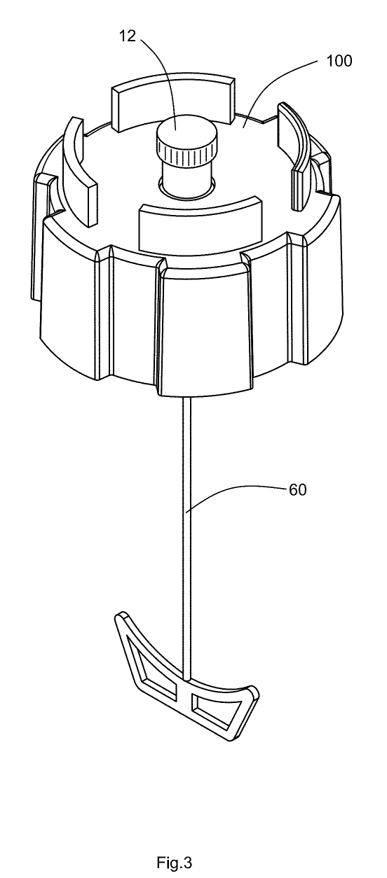

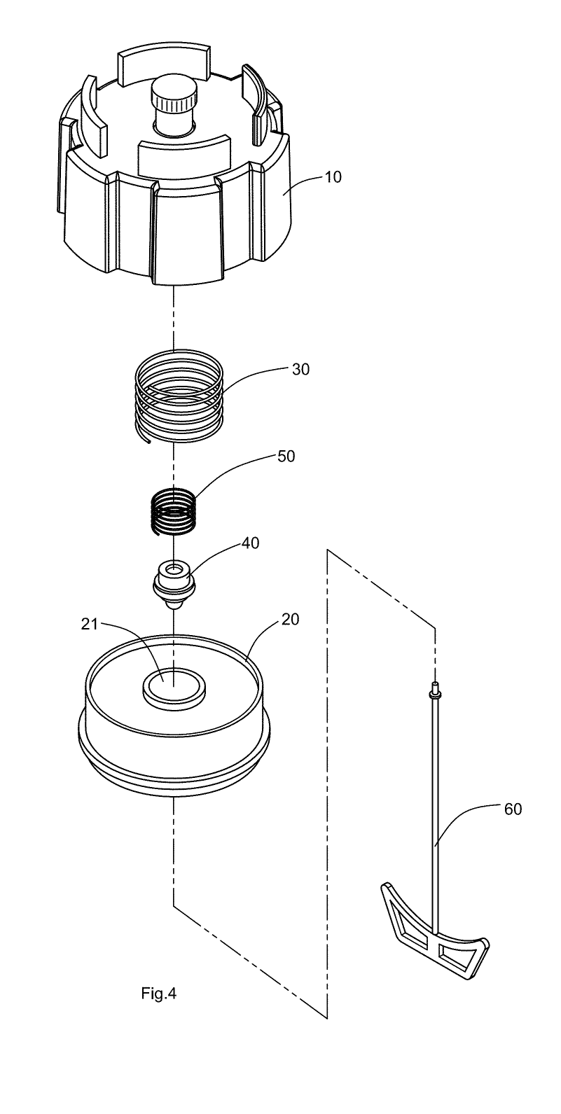

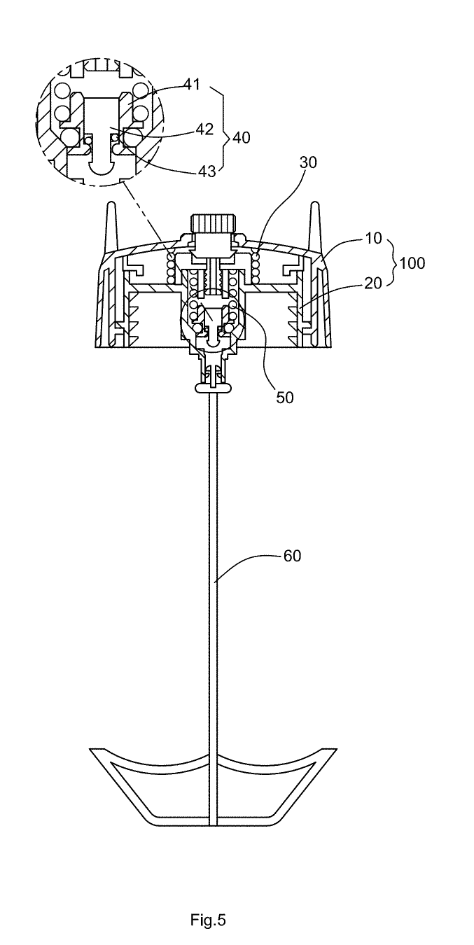

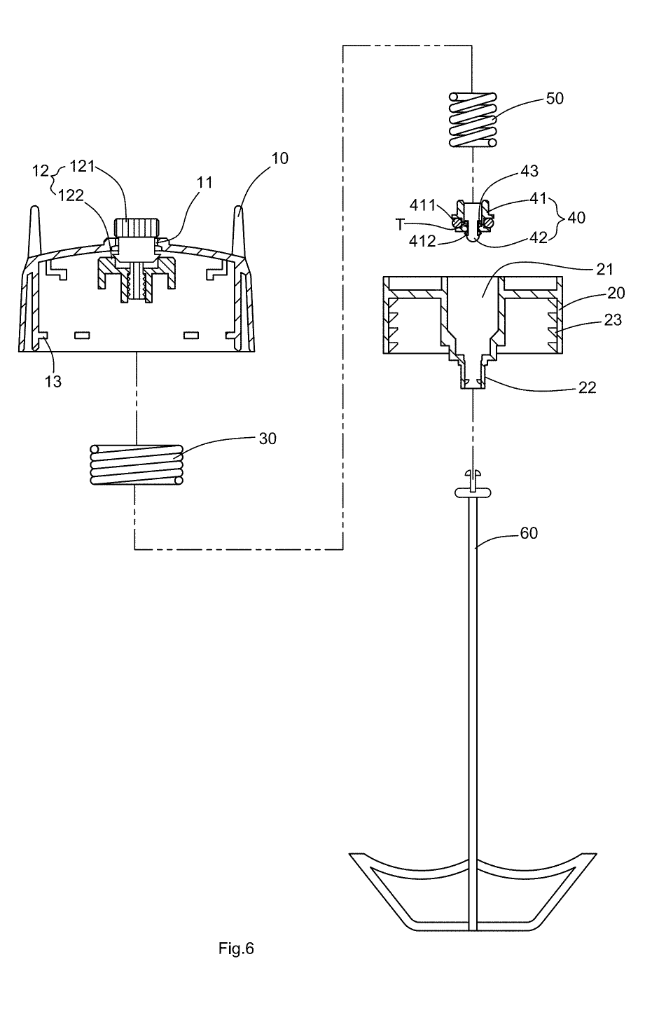

With reference to FIGS. 3-6, a fuel tank cap for two-way gas intake and exhaustion according to a preferred embodiment of the present invention comprises: a body 100 locked on an oil inlet of a fuel tank 200.

Referring to FIGS. 3-6, the body 100 includes a first lid 10 and a second lid 20 which are made of plastic material, wherein the first lid 10 has a coupling orifice 11 configured to connect with a pressure adjustment module 12. The pressure adjustment module 12 has a rotatable knob 121 and a limiting unit 122, and the first lid 10 has a locking rib 13 formed on a bottom of an inner wall thereof. A first spring 30 is defined between the inner wall of the first lid 10 and the second lid 20, a first end of the first spring 30 is fitted on an inner wall of the limiting unit 122, and a second end of the first spring 30 is fitted on an upper end of the second lid 20 so that the inner wall of the first lid 10 spaces a distance apart from the second lid 20.

As shown in FIGS. 3-6, the second lid 20 is fitted with the inner wall of the first lid 10, and a bottom of the second lid 20 retains with the locking rib 13. The second lid 20 includes an accommodation groove 21 formed on a central portion thereof, the second lid 20 includes a connection portion 22 arranged on an inner wall of the second lid 20, wherein the accommodation groove 21 is formed in an inverted cone shape, the second lid 20 further includes a threaded section 23 formed on the inner wall thereof so as to screw the body 100 with the oil inlet of the fuel tank 200.

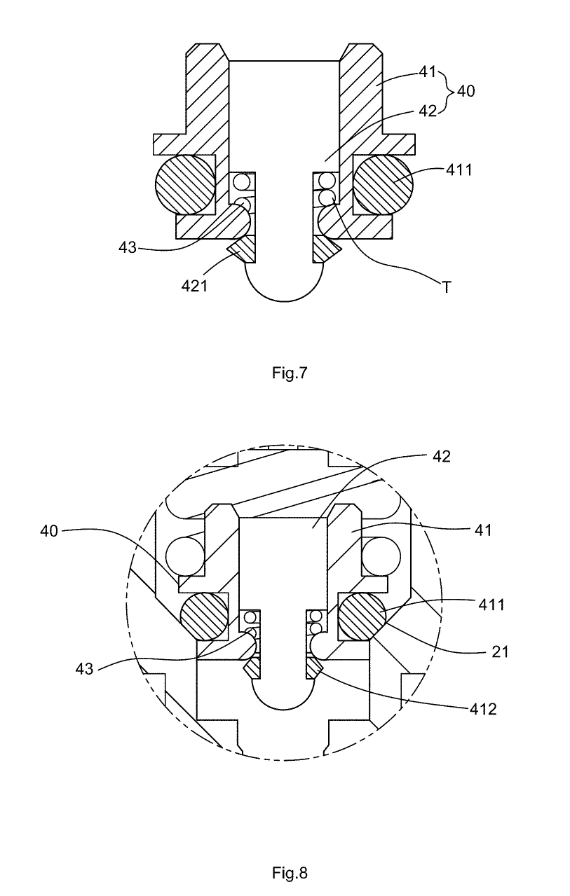

With reference to FIGS. 3-8, the accommodation groove 21 of the second lid 20 accommodates a flexible adjustment valve 40 and a second spring 50, the flexible adjustment valve 40 has a main part 41 and a flexible stop unit 42, wherein the flexible stop unit 42 is connected with the main part 41, and the flexible stop unit 42 is fitted with a flexible washer 421 so as to close the flexible stop unit 42. The flexible stop unit 42 has a movement travel T in which the flexible stop unit 42 expends or retracts. The main part 41 has at least one seal loop 411 fitted on an outer wall thereof so as to matingly contact with the accommodation groove 21, and the main part 41 has a defining rib 412, wherein a first end of the second spring 50 abuts against the defining rib 412, and a second end of the second spring 50 is biased against the limiting unit 122. The second lid 20 further includes a locating paw element 60 inserted into the fuel tank 200 and configured to prevent a removal of the body 100 from the fuel tank 200.

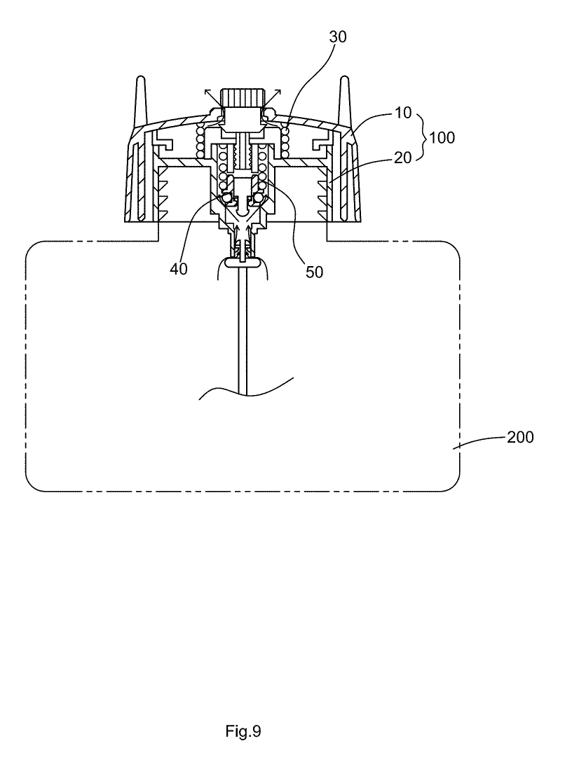

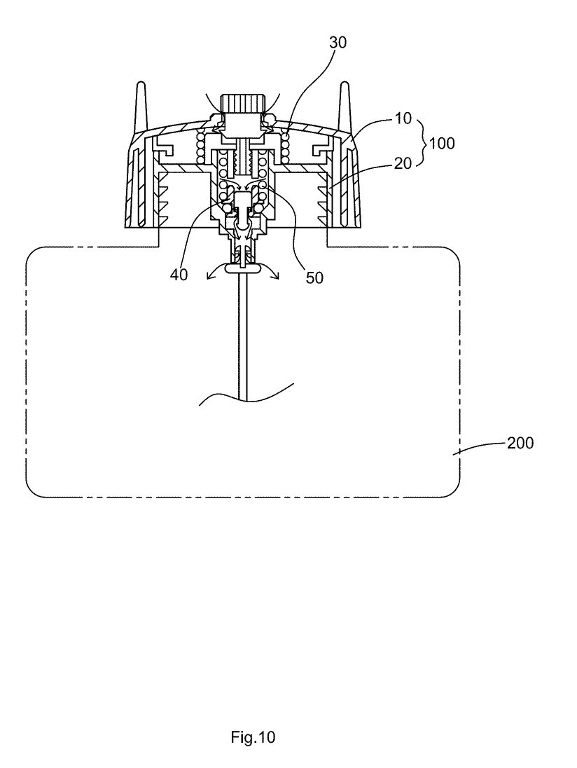

Referring to FIGS. 3-10, when a pressure produces in the fuel tank 200, the rotatable knob 121 is rotated tightly or loosely so that gas flows into the fuel tank 200 from external environment. Thereafter, the flexible stop unit 42 is pulled by the pressure of the fuel tank 200 to move downward in the movement travel T so that the gas flows into the fuel tank 200 from the external environment via the first lid 10, the second lid 20 and the flexible adjustment valve 40, and the pressure of the fuel tank 200 is equal to a pressure of the external environment.

As shown in FIGS. 3-10, when the gas exhausts out of the fuel tank 300, the flexible adjustment valve 40 is pushed by the pressure so that the gas exhausts out of the fuel tank 200 along the second lid 20 and the first lid 10. After the pressure of the fuel tank 200 is equal to that of the external environment, the second spring 30 and the second spring 50 push the flexible adjustment valve 40 to move back to an original position, thus avoiding leakage of fuel oil and the gas and enhance using safety.

To reduce the pressure of the fuel tank 200, the flexible adjustment valve 40 is carburized surface treatment so as to have anti-abrasion and high-pressure resistance. For example, the flexible adjustment valve 40 is against high pressure of 5 Psi. Furthermore, the flexible adjustment valve 40 has a returning spring 43 housed therein so that when the body 100 draws the gas, the returning spring 43 pushes the flexible stop unit 42 to descend so as to supplement the pressure of the fuel tank 200. When the pressure of the fuel tank 200 is equal to the external environment, the returning spring 43 pushes the flexible stop unit 42 to move back to an original position.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention

What is claimed is:

1. A fuel tank cap for two-way gas intake and exhaustion comprising: a body including a first lid and a second lid, the first lid having a coupling orifice configured to connect with a pressure adjustment module, the pressure adjustment module having a rotatable knob and a limiting unit, and the first lid having a locking rib formed on a bottom of an inner wall thereof; a first spring being defined between the inner wall of the first lid and the second lid, a first end of the first spring being fitted on an inner wall of the limiting unit, and a second end of the first spring being fitted on an upper end of the second lid, the second lid being fitted with the inner wall of the first lid, and a bottom of the second lid retaining with the locking rib; the second lid including an accommodation groove formed on a central portion thereof, and the second lid including a connection portion arranged on an inner wall of the second lid;
wherein the accommodation groove of the second lid accommodates a flexible adjustment valve and a second spring, and the flexible adjustment valve has a main part and a flexible stop unit, wherein the flexible stop unit is connected with the main part, and the flexible stop unit has a movement travel in which the flexible stop unit expends or retracts, the main part has at least one seal loop fitted on an outer wall thereof so as to matingly contact with the accommodation groove, and the main part has a defining rib, wherein a first end of the second spring abuts against the defining rib, and a second end of the second spring is biased against the limiting unit.

2. The fuel tank cap as claimed in claim 1, wherein the accommodation groove is formed in an inverted cone shape.

3. The fuel tank cap as claimed in claim 1, wherein the flexible stop unit is fitted with a flexible washer so as to close the flexible stop unit.

4. The fuel tank cap as claimed in claim 1, wherein the flexible adjustment valve is carburized surface treatment.

5. The fuel tank cap as claimed in claim 1, wherein the second lid further includes a threaded section formed on the inner wall thereof so as to screw the body with an oil inlet of a fuel tank.

6. The fuel tank cap as claimed in claim 1, wherein the second lid further includes a locating paw element inserted into a fuel tank and configured to prevent a removal of the body from the fuel tank.
